(19) United States
(12) Patent Application Publication
(10) Pub. No.: US 2024/0392092 A1
(43) Pub. Date: Nov. 28, 2024

(54) RECYCLED FOAM

(71) Applicant: Dow Global Technologies LLC, Midland, MI (US)

(72) Inventors: Hyunwoo Kim, Manvel, TX (US); Nolan T. McDougal, Pearland, TX (US); Jill A. Ottinger, Ambler, PA (US)

(21) Appl. No.: 18/692,918

(22) PCT Filed: Oct. 13, 2022
(86) PCT No.: PCT/US2022/078041

§ 371 Date: Mar. 18, 2024

Related U.S. Application Data
(60) Provisional application No. 63/264,245, filed on Nov. 18, 2021.

(51) Int. Cl. C08J 11/06

(52) U.S. Cl. CPC C08J 11/06; C08J 2323/04; C08J 2323/10

(57) ABSTRACT

A method is provided for recycling polyolefin foam comprising a) providing a mixture comprising fragments of poly-olefin foam and an aqueous composition comprising dispersed polyolefin particles, and b) removing water from the mixture. Also pro-vided is a composition comprising a mixture comprising polyolefin foam and an aqueous composition comprising dispersed polyolefin particles. Also provided is an article formed by a method comprising removing water from such a composition.

Polyolefin foams are used for a variety of applications including protective packaging (e.g., padding for electronic items during shipping), building & construction applications (e.g., pipe insulation), recreational items (e.g., swim noodles and fitness mats), and automotive applications. There is a growing need to recycle the foams after use, or after being manufactured for one purpose but needing to be used for a different purpose. Post-consumer recycled (PCR) or post-industrial recycled (PIR) foams can be recycled by first mechanically reducing the foam to relatively small fragments (if the foam did not already exist as relatively small fragments) and then by sintering foam fragments using one or more adhesives to form a larger, useful article. Some adhesives that might be considered for use in this way are organic solvent borne and suffer from the various health and environmental drawbacks that result from the use of organic solvents.

U.S. Pat. No. 7,837,831 discloses tissues made with an aqueous dispersion containing an olefin polymer and natural or synthetic cellulosic fibers.

It is desired to provide a method of recycling polyolefin foam that employs an aqueous adhesive that is effective at binding fragments of polyolefin foam together to form a new useful polyolefin foam article.

The following is a statement of the invention.

A first aspect of the present invention is method for recycling polyolefin foam comprising
a) providing a mixture comprising
   i) fragments of polyolefin foam and
   ii) an aqueous composition comprising dispersed polyolefin particles, and
b) removing water from the mixture.

A second aspect of the present invention is a composition comprising
i) fragments of polyolefin foam and
ii) an aqueous composition comprising dispersed polyolefin particles.

A third aspect of the present invention is an article formed by a method comprising removing water from the composition of the second aspect.

The following is a detailed description of the invention.

As used herein, the following terms have the designated definitions, unless the context clearly indicates otherwise.

As used herein, a polymer is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. A polymer has number-average molecular weight of 1,000 or higher.

As used herein “weight of polymer” means the dry weight of polymer.

As used herein, a “thermoplastic” polymer is a polymer that meets the following criteria. A thermoplastic polymer is solid over a range of temperatures from absolute zero up to Tsolid, and Tsolid is below 200° C. At some temperature (Tflow) that is equal to or greater than Tsolid, the thermoplastic polymer becomes soft enough to change to a new shape under the force of gravity or under mechanically applied force. When the thermoplastic polymer is cooled back to a temperature at or below Tsolid, the thermoplastic polymer retains approximately the new shape. The softening of the polymer may be due to a glass transition, a melting transition, some other softening process, or a combination thereof.

Molecules that can react with each other to form the repeat units of a polymer are known herein as “monomers.” The repeat units so formed are known herein as “polymerized units” of the monomer.

An “olefin” is a hydrocarbon compound that contains exactly one carbon-carbon double bond and that contains no carbon-carbon triple bonds. An olefin may be linear, cyclic, branched, or a combination thereof. A “polyolefin” is a polymer in which 40% or more by weight, based on the weight of the polymer, of the polymerized units are olefins.

As used herein, a “vinyl ester” is a compound having the formula R₃C—C(O)—O—CR═CR₂, where each R group is, independently of all the other R groups, hydrogen or a substituted or unsubstituted organic group. As used herein, “(meth)acrylic acid” means acrylic acid, methacrylic acid, or a mixture thereof. As used herein “(meth)acrylic ester” means an ester of (meth)acrylic acid, where the ester group is a substituted or unsubstituted C₁-C₂₀ alkyl group. As used herein, a “diene” is a hydrocarbon compound that has exactly two carbon-carbon double bonds and has no carbon-carbon triple bonds. A diene may be linear, branched, cyclic, or a combination thereof.

As used herein, a carboxylic compound is any of the following: carboxylic acid, with the carboxyl group in neutral form, in anion form, or a mixture thereof; a salt of a carboxylic acid; an ester of a carboxylic acid; a mixture thereof. Sulfonate compound is a compound with a sulfonic acid group, which may be in neutral form, anionic form, salt form, ester form, or a mixture thereof.

As used herein, a “foam” is a solid article that contains multiple cells. A cell is a gas-filled volume that is partially or fully surrounded by solid material. When 50% or more by number of the cells are fully surrounded by solid material, the foam is known as a “closed-cell” foam. Other foams are known as “open-cell” foams. A foam in which 50% or more by weight is polyolefin is known as a “polyolefin foam.” If the polyolefin foam contains more than one polyolefin, the polyolefin in the foam having the largest weight percentage, based on the weight of the foam, is known herein as the “principal” polyolefin in the foam. If the polyolefin foam contains exactly one polyolefin, that polyolefin is the principal polyolefin.

A piece of polyolefin foam that has no dimension larger than 20 cm is known herein as a “fragment.” A fragment of polyolefin foam may be in a form in which it was found, or a larger piece of polyolefin foam may be reduced to fragments, for example, by one or more mechanical processes, such as, for example, grinding, chopping, shearing, breaking, other mechanical processes, or any combination thereof.

As used herein, a “particle” is a discrete article. A particle may be solid or liquid. As used herein, the “diameter” of a particle is considered to be the diameter of an imaginary sphere having the same volume as the actual particle. The “aspect” ratio of a particle is the ratio of its largest dimension to its smallest dimension. A particle is said herein to be “non-fibrous” if its aspect ratio is 2:1 or lower. A “polyolefin particle” contains 50% or more polyolefin by weight based on the weight of the particle.

As used herein, an “aqueous” composition is a composition that contains 30% or more water, by weight based on the weight of the composition. An aqueous medium is a continuous liquid medium that contains 50% or more water, by weight based on the weight of the medium. Particles are said herein to be “dispersed” in a liquid medium when the particles are distributed throughout the liquid medium. Particles that are dispersed in a liquid medium may form, for example, a composition that is normally labeled a slurry, a dispersion, an emulsion, a latex, some other type of composition, or a combination thereof. A collection of particles dispersed in a liquid medium is characterized by the volume-average diameter, which may be measured by light scattering, for example by a Coulter LS230 device (Beckman Coulter Co., Indianapolis, IN, USA). The particle size distribution quotient is defined herein as the quotient obtained by dividing the volume-average particle diameter Dv by the number-average particle diameter Dn.

The melting temperature of a polymer is measured by Differential Scanning calorimetery (DSC). An endothermic peak is observed at the melting temperature.

The crystallinity of a polymer is measured by observing the heat of fusion at the melting point that occurs in a DSC evaluation. The “crystallinity” is determined by normalizing the observed heat of fusion to that of a 100% crystalline sample of the same polymer, reported as a percentage.

The weight-average molecular weight (Mw) of a polymer sample is measured by light scattering in a dilute solutions of the polymer, using the intercept of a Zimm plot of scattering intensity versus polymer concentration and scattering angle. The polydispersity index is defined as the quotient obtained by dividing the weight-average molecular weight (Mw) by the number-average molecular weight (Mn).

The glass transition temperature (Tg) of a polymer sample is measured by DSC at 10° C./min as the midpoint in a step change in the heat flow curve.

The melt index (“I2”) of a polymer is measured by following ASTM D1238, Condition 190° C./2.16 kg. The I2 is reported in grams eluted per 10 minutes (g/10 min).

Ratios presented herein are characterized as follows. For example, if a ratio is said to be 3:1 or greater, that ratio may be 3:1 or 5:1 or 100:1 but may not be 2:1. This characterization may be stated in general terms as follows. When a ratio is said herein to be X:1 or greater, it is meant that the ratio is Y:1, where Y is greater than or equal to X. For another example, if a ratio is said to be 15:1 or less, that ratio may be 15:1 or 10:1 or 0.1:1 but may not be 20:1. In general terms, when a ratio is said herein to be W:1 or less, it is meant that the ratio is Z:1, where Z is less than or equal to W.

Preferably, the volume-average particle diameter of the dispersed particles in the aqueous composition is 10 micrometers or less; more preferably 5 micrometers or less; more preferably 2.5 micrometers or less; more preferably 1.5 micrometers or less. Preferably, the volume-average particle diameter of the dispersed particles in the aqueous composition is 0.05 micrometers or larger; more preferably 0.1 micrometers or larger; more preferably 0.2 micrometers or larger. Preferably, the particle size distribution quotient of the dispersed particles in the aqueous composition is 2 or lower; more preferably 1.9 or lower; more preferably 1.7 or lower; more preferably 1.5 or lower.

Examples of suitable aqueous compositions containing dispersed polyolefin particles are disclosed, for instance, in U.S. Pat. Nos. 5,688,842; 8,053,503; and 8,163,837.

The polyolefin particles preferably contain polyolefin in an amount, by weight based on the total weight of the particles, of 50% or more; more preferably 60% or more; more preferably 70% or more; more preferably 80% or more; more preferably 90% or more.

Preferably, the polyolefin particles contain one or more “first polyolefins.” In a “first polyolefin,” polymerized units of olefins are present in an amount, by weight based on the weight of the first polyolefin, 70% or more; more preferably 80% or more; more preferably 90% or more. Preferably, the first polyolefin contains polymerized units of one or more primary monomer, optionally one or more comonomer, and optionally one more additional monomer. Primary monomer is ethylene, propylene, or a mixture thereof. Comonomer is selected from the group of one or more dienes, one or more vinyl esters, one or more compound of formula H₂C═CHR (where R is a C₂-C₂₀ linear, branched, or cyclic alkyl group; or a C₆-C₂₀ aryl group), and mixtures thereof.

In the first polyolefin, preferably, the polymerized units of primary monomer are, by weight based on the weight of polymerized units of primary monomer, either 90% to 100% polymerized units of ethylene or 90% to 100% polymerized units of propylene; more preferably 90% to 100% polymerized units of ethylene; more preferably 100% polymerized units of ethylene. In the first polyolefin, preferably, the amount of polymerized units of primary monomer is, by weight based on the weight of the first polyolefin, 65% or more; more preferably 75% or more. In the first polyolefin, preferably, the amount of polymerized units of primary monomer is, by weight based on the weight of the first polyolefin, 100% or less; more preferably 99% or less; more preferably 90% or less.

Regarding the one or more comonomers, if one or more diene is used in the first polyolefin, preferred are C₄-C₂₀ linear, branched or cyclic dienes. If one or more vinyl ester is used in the first polyolefin, preferred is vinyl acetate. If one or more compounds having formula H₂C═CHR (as defined above) is used in the first polyolefin, preferred are 1-butene, 3-methyl-1-butene, 4-methyl-1-pentene, 3-methyl-1-pentene, 1-heptene, 1-hexene, 1-octene, 1-decene, 1-dodecene, and mixtures thereof; more preferred are 1-heptene, 1-hexene, 1-octene, 1-decene, 1-dodecene, and mixtures thereof. In the first polyolefin, preferably the comonomer includes one or more compound of formula H₂C═CHR. In the first polyolefin, preferably the amount of compound of formula H₂C═CHR in the comonomer is, by weight based on the weight of comonomer, 50% or more; more preferably 75% or more; more preferably 90% or more; more preferably 100%. Preferably the amount of polymerized units of comonomer in the first polyolefin is, by weight based on the weight of the first polyolefin, 0 to 25%, more preferably 1% to 25%.

Regarding the additional monomer in the first polyolefin, preferably any additional monomer that is used is different from any primary monomer and is different from any comonomer. Preferably, little or no polymerized units of additional monomer are present in the first polyolefin. That is, preferably the amount of polymerized units of additional monomer that is present in the first polyolefin is, by weight based on the weight of the first polyolefin, 0 to 10%; more preferably 0 to 1%; more preferably 0%.

Preferably, the first polyolefin is thermoplastic. Preferably, the first polyolefin has crystallinity of less than 50%, preferably less than 25%. Preferably, the first polyolefin has weight average molecular weight of 15,000 or higher; more preferably 20,000 or higher. Preferably, the first polyolefin has weight average molecular weight of 5,000,000 or lower; more preferably 1,000,000 or lower. Preferably the molecular weight polydispersity index of the first polyolefin is 1.01 or higher, more preferably 1.5 or higher, more preferably 1.8 or higher. Preferably the molecular weight polydispersity index of the first polyolefin is 40 or lower; more preferably 20 or lower; more preferably 10 or lower.

Preferably, the first polyolefin has glass transition temperature of 50° C. or lower; more preferably 40° C. or lower. Preferably, the first polyolefin has glass transition temperature of 25° C. or higher; more preferably 30° C. or higher. Preferably, the first polyolefin has a melt temperature of 140° C. or lower; more preferably 130° C. or lower; more preferably 120° C. or lower. Preferably, the first polyolefin has melt index, in units of grams per 10 minutes, of 0.001 or higher; more preferably 0.5 or higher; more preferably 100 or higher. Preferably, the first polyolefin has melt index, in units of grams per 10 minutes, of 1,000 or lower; more preferably 800 or lower; more preferably 700 or lower.

Examples of suitable first polyolefins include, for example, the following: heterogeneously branched polyolefins, including linear low density polyethylene (LLDPE) and copolymers; heterogeneously branched ultralow linear density polyethylene (ULDPE); homogeneously branched linear copolymers of ethylene and one or more alpha-olefin other than ethylene; and homogeneously branched substantially linear copolymers of ethylene and one or more alpha-olefin other than ethylene.

Preferably the aqueous composition additionally contains one or more dispersant. A dispersant molecule may reside dissolved in the continuous aqueous phase or may reside attached to one or more polyolefin particle, or may reside partially on the surface of a polyolefin particle and partially in the continuous aqueous phase. Suitable dispersants include non-polymeric carboxylic compounds, non-polymeric sulfonate compounds, olefin/(meth)acrylic acid copolymers, sulfated or phosphated polyoxyethylenated alcohols, ethylene oxide/propylene oxide/ethylene oxide block copolymers, primary and secondary alcohol ethoxylates, alkyl glycosides, alkyl glycerides, and mixtures thereof.

Among non-polymeric carboxylic compounds, preferred are those in which the carboxylic acid portion of the molecule contains 8 or more carbon atoms; more preferably 12 or more carbon atoms; more preferably 15 or more carbon atoms. Among non-polymeric carboxylic compounds, preferred are those in which the carboxylic acid portion of the molecule contains 60 or fewer carbon atoms; more preferably 30 or fewer carbon atoms. Among non-polymeric carboxylic compounds, preferred are salts in which the cation is selected from alkali metal cations, alkaline earth cations, ammonium cation, alkyl ammonium cations, or a mixture thereof.

Preferably, the dispersant includes one or more olefin/(meth)acrylic acid copolymers. Among olefin/(meth)acrylic acid copolymers, preferred are copolymers that include polymerized units of ethylene, propylene or a mixture thereof. Among olefin/(meth)acrylic acid copolymers, preferably the polymerized units of olefin monomers are, by weight based on the weight of all polymerized units of olefin monomers, either 90% to 100% polymerized units of ethylene or 90% to 100% polymerized units of propylene; more preferably 90% to 100% polymerized units of ethylene; more preferably 100% polymerized units of ethylene. Among olefin/(meth)acrylic acid copolymers, preferably the amount of polymerized units of olefin monomers is, by weight based on the weight of the olefin/(meth)acrylic acid copolymer, preferably 40% or more; more preferably 50% or more. Among olefin/(meth)acrylic acid copolymers, preferably the amount of polymerized units of olefin monomers is, by weight based on the weight of the olefin/(meth)acrylic acid copolymer, preferably 98% or less; more preferably 95% or less; more preferably 90% or less; more preferably 70% or less.

Among olefin/(meth)acrylic acid copolymers, preferably the olefin/(meth)acrylic acid copolymer contains 2% or more by weight, based on the weight of the olefin/(meth)acrylic acid copolymer, polymerized units of (meth)acrylic acid. More preferably, the amount of polymerized units of (meth)acrylic acid in the olefin/(meth)acrylic acid copolymer is, by weight based on the weight of the olefin/acrylic copolymer, 5% or more; more preferably 10% or more; more preferably 30% or more. Preferably, the amount of polymerized units of (meth)acrylic acid in the olefin/(meth)acrylic acid copolymer is, by weight based on the weight of the olefin/(meth)acrylic acid copolymer, 60% or less; more preferably 50% or less.

An olefin/(meth)acrylic acid copolymer optionally contains polymerized units of one or more additional monomers; i.e., monomers other that olefin monomers and (meth)acrylic acid. Preferably, little or no polymerized units of additional monomer are present in the olefin/(meth)acrylic acid copolymer. That is, preferably the amount of polymerized units of additional monomer that is present in the olefin/(meth)acrylic acid copolymer is, by weight based on the weight of the olefin/(meth)acrylic acid copolymer, 0 to 10%; more preferably 0 to 1%; more preferably 0%.

Preferably, the aqueous composition contains both one or more first polyolefins and one or more dispersants. Preferably, the weight ratio of first polyolefin to dispersant is 300:1 or lower. Preferably, the weight ratio of first polyolefin to dispersant is 0.5:1 or higher.

When the dispersant contains one or more olefin/(meth)acrylic acid copolymer, preferably, the weight ratio of first polyolefin to olefin/(meth)acrylic acid copolymer is 20:1 or lower; more preferably 10:1 or lower; more preferably 6:1 or lower. When the dispersant contains one or more olefin/(meth)acrylic acid copolymer, preferably, the weight ratio of first polyolefin to dispersant is 0.5:1 or higher; more preferably 0.75:1 or higher; more preferably 1:1 or higher.

When the dispersant contains one or more non-polymeric carboxylic compounds, preferably the weight ratio of first polyolefin to non-polymeric carboxylic compound is 300:1 or lower; more preferably 200:1 or lower; more preferably 120:1 or lower. When the dispersant contains one or more non-polymeric carboxylic compounds, preferably the weight ratio of first polyolefin to non-polymeric carboxylic compound is 5:1 or higher; more preferably 10:1 or higher; more preferably 16:1 or higher.

The aqueous composition contains a continuous liquid medium and also contains dispersed polyolefin particles. The amount of water in the continuous liquid medium is preferably, by weight based on the weight of the continuous liquid medium, 50% or more; more preferably 75% or more; more preferably 85% or more.

Preferably, the amount of polyolefin in the aqueous composition is, by weight based on the weight of the aqueous composition, 25% or higher; more preferably 30% or higher; more preferably 35% or higher; more preferably 40% or higher. Preferably, the amount of polyolefin in the aqueous composition is, by weight based on the weight of the aqueous composition, 75% or lower; more preferably 70% or lower; more preferably 60% or lower, more preferably 50% or lower.

Preferably, the pH of the aqueous composition is 5 or higher; more preferably 7 or higher. Preferably, the pH of the aqueous composition is 11.5 or lower; more preferably 11 or lower. Optionally, the pH of the aqueous composition may be adjusted by inclusion of one or more acids or bases in the aqueous composition.

The present invention also involves the use of fragments of polyolefin foam. Preferably, the polyolefin foam is recycled. Preferably, polyolefin is present in the foam in the amount, by weight based on the weight of the foam, of 60% or more; more preferably 70% or more; more preferably 80% or more. In the polyolefin foam, preferably, the amount of the polymerized units of primary monomer is, by weight based on the weight of polymerized units of primary monomer, either 90% to 100% polymerized units of ethylene or 90% to 100% polymerized units of propylene; more preferably 90% to 100% polymerized units of ethylene; more preferably 100% polymerized units of ethylene. In the polyolefin foam, preferably, the amount of polymerized units of primary monomer is, by weight based on the weight of all polymerized units in the polyolefin foam, 75% to 100%; more preferably 90% to 100%. In the polyolefin foam, preferably, the amount of polymerized units of comonomer is, by weight based on the weight of all polymerized units in the polyolefin foam, 0% to 25%; more preferably 0% to 10%. Preferably, the polyolefin in the polyolefin foam contains low density polyethylene (LDPE), in an amount, by weight based on the weight of polyolefin foam, of 80% or more; or 90% or more.

Preferably, the principal polyolefin in the polyolefin foam is either crosslinked or else has melting temperature (Tmfoam) of 150° C. or lower; more preferably either crosslinked or having Tmfoam of 120° C. or lower. Preferably, the principal polyolefin in the polyolefin foam is either crosslinked or else has melting temperature (Tmfoam) of 60° C. or higher; more preferably either crosslinked or having Tmfoam of 80° C. or higher.

The polyolefin foam optionally contains one or more nucleating agents. Suitable nucleating agents include, for example, talc, citric acid, and sodium bicarbonate. The amount of nucleating agents in the polyolefin foam, when present, is preferably, by weight based on the weight of the polyolefin foam, 15% or less.

The polyolefin foam optionally contains one or more foaming agents. A suitable foaming agent is, for example, glycerol monostearate. The amount of foaming agents in the polyolefin foam, when present, is preferably, by weight based on the weight of the polyolefin foam, 5% or less.

The polyolefin foam may be open cell foam or closed cell foam or a combination thereof. Suitable polyolefin foams may be, for example, high density foams or low density foams. High density foams typically have volume-average cell size of 50 to 200 micrometers. High density foams typically have density higher than 240 kg/m³ (15 lb/ft³). Low density foams typically have volume-average cell size of 100 to 3,000 micrometers. Low density foams typically have density of 8 kg/m³ (0.5 lb/ft³) to 240 kg/m³ (15 lb/ft³).

The polyolefin in the polyolefin foam may be thermoplastic or may be crosslinked. Either type of foam is suitable for use in the present invention. Of particular interest in the practice of the present invention are crosslinked foams, because crosslinked foams typically cannot be recycled by melting and re-forming, and therefore the present invention is advantageous because it provides a way of making a new useful article from previously-used crosslinked foams.

In the practice of the present invention, the polyolefin foam is present in the form of plural fragments. Each fragment may be characterized by its largest dimension (“DMAX”). The collection of fragments may be characterized by D90, which is the size such that 90% or more of the fragments, by weight based on the weight of all the fragments, have DMAX equal to or less than D90. Preferably, D90 of the collection of fragments of polyolefin foam is 20 cm or less; more preferably 12 cm or less; more preferably 7 mm or less. Preferably, 90% or more of the fragments, by weight based on the weight of all the fragments, are non-fibrous.

In some embodiments, the foam will have been manufactured, for example by extrusion, as a relatively large article, for example as a sheet, board, or plank; and then mechanically reduced to smaller fragments. It is contemplated that, other than the size reduction, these foam fragments would retain the properties of the original foam articles, such as cell sizes, foam density, and porosity.

The present invention involves the use of a mixture of fragments of the polyolefin foam and the aqueous composition. The mixture may be made by any method. Examples of suitable methods include, for example, the following: blending (for example, bringing the aqueous composition and the fragments of polyolefin foam together in a container and stirring the mixture); dip coating (for example, placing the aqueous composition in a first container, dipping the fragments of polyolefin foam into the aqueous composition until the fragments of polyolefin foam are coated by the aqueous composition, then removing the coated fragments of polyolefin foam to another container); spray coating (for example, spraying the aqueous composition onto the fragments of polyolefin foam); other methods; and combinations thereof.

In one preferred embodiment one or the other of the following conditions (“I” or “II”) is present:
I) the dispersed polyolefin particles comprise 50% or more by weight of polymerized units of ethylene, based on the total weight of all polymerized units in all polymers in the dispersed polyolefin particles,
   and
   the fragments of polyolefin foam comprise 50% or more by weight of polymerized units of ethylene, based on the total weight of all polymerized units in the fragments of polyolefin foam

### OR

II) the dispersed polyolefin particles comprise 50% or more by weight of polymerized units of propylene, based on the total weight of all polymerized units in all polymers in the dispersed polyolefin particles,
   and
   the fragments of polyolefin foam comprise 50% or more by weight of polymerized units of propylene, based on the total weight of all polymerized units in the fragments of polyolefin foam.

Condition I is preferred. When condition I is practiced, preferably the amount of polymerized units of ethylene in all the polymers in the dispersed polyolefin particles is, by weight based on the total weight of all polymerized polyolefin particles, 60% or more; more preferably 70% or more; more preferably 80% or more. When condition I is practiced, preferably the amount of polymerized units of ethylene in the polyolefin foam, by weight based on the total weight of all polymerized units in the fragments of polyolefin foam, is 60% or more; more preferably 70% or more; more preferably 80% or more.

When condition II is practiced, preferably the amount of polymerized units of propylene in all polymers in the dispersed polyolefin particles is, by weight based on the total weight of all polymerized polyolefin particles, 60% or more; more preferably 70% or more; more preferably 80% or more. When condition II is practiced, preferably the amount of polymerized units of propylene in the polyolefin foam, by weight based on the total weight of all polymerized units in the fragments of polyolefin foam, is 60% or more; more preferably 70% or more; more preferably 80% or more.

The mixture of the aqueous composition and the polyolefin foam fragments may be characterized by the ratio of the weight of polyolefin in the aqueous composition to the weight of the polyolefin foam. Preferably, that ratio is 0.2:1 or higher; more preferably 0.5:1 or higher; more preferably 0.75:1 or higher. Preferably, that ratio is 5:1 or lower; more preferably 3:1 or lower.

The practice of the present invention involves removing water from the mixture of the aqueous composition and the polyolefin foam particles. Preferably, the water is removed by a process involving evaporation of the water. To speed up the removal of water, the mixture may be subjected, for example, to one or more of the following: temperature above 30° C.; moving air; and combinations thereof.

When temperature above 30° C. is used, preferred is 60° C. or above; more preferred is 70° C. or above. When temperature above 30° C. is used, preferred is 150° C. or lower; more preferred is 125° C. or lower. Temperature above 30° C. may be achieved by any method. Some suitable methods include, for example, exposure to radiation (such as, for example, infrared), exposure to heated gas (such as, for example, heated air), other heating methods, and combinations thereof.

When moving air is desired to be used, one suitable method is to place the mixture into an oven that mechanically forces air to move within the oven, such as, for example, a convection oven. When a mixture is placed in an oven that mechanically forces air to move within the oven, the mixture may be simultaneously exposed to both moving air and temperature above 30° C. Alternatively, the mixture may be exposed to moving air (with or without simultaneous exposure to temperature above 30° C.) in a setting other than in an oven. Alternatively, moving air may not be used.

When the mixture is exposed to temperature above 30° C., it is preferred that the mixture reaches a temperature that is equal to or greater than Tflow of the first polyolefin. It is contemplated that when the mixture reaches a temperature of Tflow of the first polyolefin or greater, some or all of the particles containing the first polyolefin will tend to fuse with each other and bind the fragments of polyolefin foam into a single mass.

It is contemplated that exposure to temperature above 30° C. will aid both in the fusing of particles of the first polyolefin and the removal of water from the mixture. These effects may be achieved in either order or may be achieved simultaneously, or any combination thereof. For example, the mixture may be first exposed to conditions that optimize removal of water (for example, relatively low temperature and relatively high air flow) and then exposed to conditions that optimize fusion of particles (for example, relatively high temperature). For another example, the mixture may be first exposed to conditions that optimize fusion of particles and then exposed to conditions that optimize removal of water. For another example, conditions may be chosen that allow particle fusion and water removal to occur simultaneously. It is contemplated that when conditions are applied that optimize or favor one effect (for example, water removal), the other process (for example, particle fusion) will occur simultaneously to some extent.

When the mixture is exposed to temperature above 30° C., and when the principal polyolefin in the polyolefin foam is thermoplastic, the maximum temperature Tmax attained by the mixture should obey Tmax<(T2−10° C.), where T2 is Tsoft of the principal polyolefin in the polyolefin foam. It is expected that keeping Tmax below a temperature that is 10° C. below T2 will allow the fragments of polyolefin foam to retain their foam structure without collapsing.

Optionally, the mixture is subjected to mechanical pressure while at temperature sufficient to soften some or all of the polyolefin in the particles from the aqueous composition.

After removal of water from the mixture and, if it had been heated, returning it to ambient temperature of approximately 25° C., the remaining composition is considered herein to be a finished article. It is contemplated that some water may be retained in the finished article. Preferably the amount of water in the finished article is, by weight based on the weight of the finished article, 20% or less; more preferably 10% or less; more preferably 5% or less.

The fragments of polyolefin foam may be, for example, placed into a container that serves as a mold to determine the final shape of the finished article. The fragments of polyolefin foam may be placed into such a container either before or after the fragments of polyolefin foam are brought into contact with the aqueous composition.

The following are examples of the present invention. Operations were performed at room temperature (approximately 23° C.) except where otherwise stated. The following materials were used:
“Binder”=HYPOD™ 8501 aqueous acid-modified ethylene copolymer based polyolefin dispersion, approximately 45% solids by weight, from Dow Chemical Company
Recycled Foam: previously manufactured polyolefin foam had been reduced to fragments having D90 less than 5 mm.

### EXAMPLE 1

97 grams of Binder was mixed with Recycled Foam in a bath until uniform coverage of Binder on the foam particles was achieved. The Binder-coated foam particles were placed in a heavy duty aluminum loaf pan of size 21.6 cm×11.7 cm×7.0 cm (8.5 inch×4.6 inch×2.75 inch). Another pan was used as a lid, and the sample was placed in a convection oven set at 90° C. for 50 min with a weight of 1.8 kg (4 pounds) placed on top of the lid. Then the lid was removed and the sample was dried in an oven at 90° C. for 2 hours.

### EXAMPLE 2

Identical to Example 1 except that the lid was perforated.

### EXAMPLE 3

Binder was spray coated evenly onto 15 grams of Recycled Foam. The spray-coated foam particles were placed in an oven at 90° C. for 30 minutes. Then the coated foam was weighed, and the result was 16.7 grams, demonstrating that 1.6 grams of polymer from the Binder coated 15 grams of Recycled Foam particles. The coated foam particles were placed in a pan that was then covered with a lid. On the lid was placed a 1.8 kg (4 pound) weight. The pan was placed in an oven at 90° C. for 10 minutes. An additional 1.8 kg (4 pound) weight was placed on the lid, and the pan was placed in the oven at 90° C. for an additional 10 minutes.

### EXAMPLE 4

15 grams of foam was dipped into a bath of Binder and mixed until uniform coating was achieved. The Dip-coated foam particles were placed in an oven at 90° C. for 50 minutes. Then the coated foam particles weighed 30 grams, demonstrating that 15 grams of polymer from the Binder coated 15 grams of Recycled Foam. The coated foam particles were then placed in a pan with a lid with a 1.8 kg (4 pound) weight in an oven at 90° C. for 5 minutes. An additional 1.8 kg (4 pound) weight was placed on the lid, and the pan was placed in the oven at 90° C. for an additional 10 minutes.

The result of each of Examples 1-4 was a solid block containing polyolefin foam that was sturdy when handled and appeared to useful for any of a wide variety of uses such as, for example, protective packaging (e.g., padding for electronic items during shipping), building & construction applications (e.g., pipe insulation), recreational items (e.g., swim noodles and fitness mats), and automotive applications.

1. A method for recycling polyolefin foam comprising
a) providing a mixture comprising
i) fragments of polyolefin foam and
ii) an aqueous composition comprising dispersed polyolefin particles, and
b) removing water from the mixture.

2. The method of claim 1, further comprising the step of
c) causing or allowing some or all of the dispersed polyolefin particles to fuse with each other.

3. The method of claim 1, wherein the dispersed polyolefin particles have volume-average particle diameter of 0.05 micrometers to 10 micrometers.

4. The method of claim 1, wherein the dispersed polyolefin particles comprise a first polyolefin comprising polymerized units, by weight based on the weight of the first polyolefin, of
i) 65% to 99% ethylene or propylene or a mixture thereof;
ii) 1% to 25% one or more monomers selected from the group consisting of one or more dienes, one or more vinyl esters, one or more compound of formula H₂C═CHR, wherein R is a C₂-C₂₀ linear, branched, or cyclic alkyl group, or a C₆-C₂₀ aryl group, and mixtures thereof, and
iii) 0% to 10% one or more monomers different from i) and ii).

5. The method of claim 1, wherein the aqueous composition further comprises one or more olefin/(meth)acrylate copolymer.

6. The method of claim 1, wherein the dispersed polyolefin particles comprise 50% or more by weight of polymerized units of ethylene, based on the total weight of all polymerized units in all polymers in the dispersed polyolefin particles, and wherein the fragments of polyolefin foam comprise 50% or more by weight of polymerized units of ethylene, based on the total weight of all polymerized units in the fragments of polyolefin foam.

7. The method of claim 1, wherein the dispersed polyolefin particles comprise 50% or more by weight of polymerized units of propylene, based on the total weight of all polymerized units in all polymers in the dispersed polyolefin particles, and wherein the fragments of polyolefin foam comprise 50% or more by weight of polymerized units of propylene, based on the total weight of all polymerized units in the fragments of polyolefin foam.

8. The method of claim 1, wherein the fragments of polyolefin foam comprise 80% or more of low density polyethylene by weight based on the total weight of the fragments of polyolefin foam.

9. A composition comprising
i) fragments of polyolefin foam and
ii) an aqueous composition comprising dispersed polyolefin particles.

10. An article formed by a method comprising removing water from the composition of claim 9.
